(19) United States
(12) Patent Application Publication
(10) Pub. No.: US 2009/0048732 A1
(43) Pub. Date: Feb. 19, 2009

(54) RECORDING DEVICE FOR AUTOMOBILE

(75) Inventor: SHOU-SHU KAO, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: CHI MEI COMMUNICATION SYSTEMS, INC., Tu-Cheng City (TW)

(21) Appl. No.: 11/964,581

(22) Filed: Dec. 26, 2007

(30) Foreign Application Priority Data
Aug. 14, 2007 (CN) 200710201362.7

(51) Int. Cl. G06F 7/00

(52) U.S. Cl. 701/36

(57) ABSTRACT

A recording device (100) installed in an automobile (200) includes a controlling module (10), an outboard detecting module (20) and an alert module (40). The outboard detecting module includes at least one image sensing apparatus (21) configured for transforming images out of the automobile into image signals. The controlling module is electronically connected to the outboard detecting module, and is configured for receiving, processing and storing the image signals transferred from the outboard detecting module. The alert module is electronically connected to the controlling module, and is configured for instantaneously displaying the image signals.

### BACKGROUND OF THE INVENTION

1. Field of the Invention

The present invention relates to recording devices for automobiles, particularly to a recording device receiving and storing image data for automobiles.

2. Description of Related Art

Nowadays, recording devices are widely used in automobiles. A recording device is installed in an automobile for detecting, displaying and storing relative data, such as speed of a vehicle, distance, time tire pressure and so on. The detected data can be shown to the driver and passengers when the automobile is in use.

When an automobile is in use, an image data outside of an automobile can be received, stored and displayed by typical recording device installed in the automobile. The stored data can be used as valuable information to the driver/passenger of the automobile condition and also for accident investigation. However, most outboard images of an automobile are still being received and shown by means of typical rearview mirrors or image sensing apparatuses. Generally, these typical apparatuses can only receive and display images, but cannot store images. On the other hand, most typical record apparatuses have no function of receiving images instantaneously, thus lacks the ability of receiving and displaying images in real-time.

Therefore, a new recording device is desired in order to overcome the above-described shortcomings.

### SUMMARY

A recording device installed in an automobile includes a controlling module, an outboard detecting module and an alert module. The outboard detecting module includes at least one image sensing apparatus configured for transforming images out of the automobile into image signals. The controlling module is electronically connected to the outboard detecting module, and is configured for receiving, processing and storing the image signals transferred from the outboard detecting module. The alert module is electronically connected to the controlling module, and is configured for instantaneously displaying the image signals.

Other advantages and novel features will become more apparent from the following detailed description when taken in conjunction with the accompanying drawings.

### BRIEF DESCRIPTION OF THE DRAWINGS

Many aspects of the present recording device can be better understood with reference to the following drawings. The components in the various drawings are not necessarily drawn to scale, the emphasis instead being placed upon clearly illustrating the principles of the present recording device. Moreover, in the drawings, like reference numerals designate corresponding parts throughout the diagrams.

FIG. 1 is a diagram of a recording device, in accordance with a present embodiment;

FIG. 2 is a diagram of an image sensing apparatus of the recording device shown in FIG. 1; and

FIG. 3 is a diagram of the recording device shown in FIG. 1 installed in an automobile.

### DETAILED DESCRIPTION OF THE INVENTION

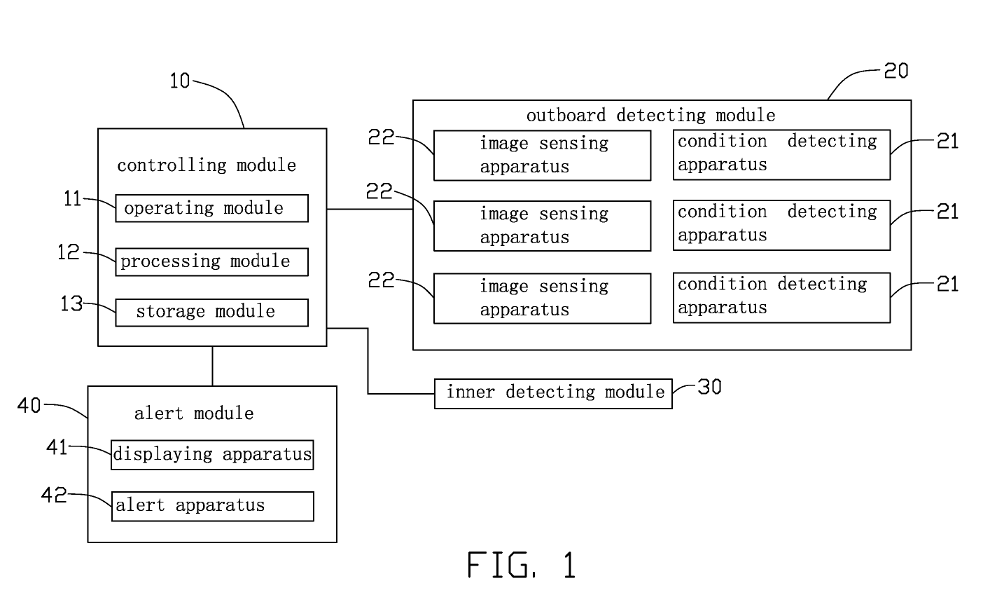

Referring now to the drawings in detail, FIG. 1 shows a recording device 100, in accordance with a present embodiment. The recording device 100 can be installed in an automobile to receive, store and display image data instantaneously during operation of an automobile.

The recording device 100 includes a controlling module 10, an outboard detecting module 20, an inner detecting module 30 and an alert module 40. The controlling module 10 is a data processor (e.g. a computer) electronically connected to the outboard detecting module 20, the inner detecting module 30 and the alert module 40 and configured for controlling these modules. The controlling module 10 includes an operating module 11, a processing module 12 and a storage module 13. The operating module 11 is a typical operating apparatus such as a keypad used to manipulate the controlling module 10. The processing module 12 is a central processing unit (CPU) of the controlling module 10 used to process data. The storage module 13 is used to store data.

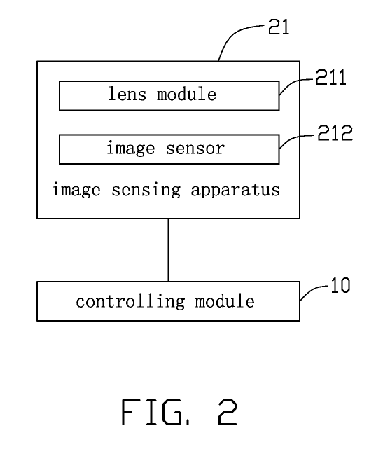

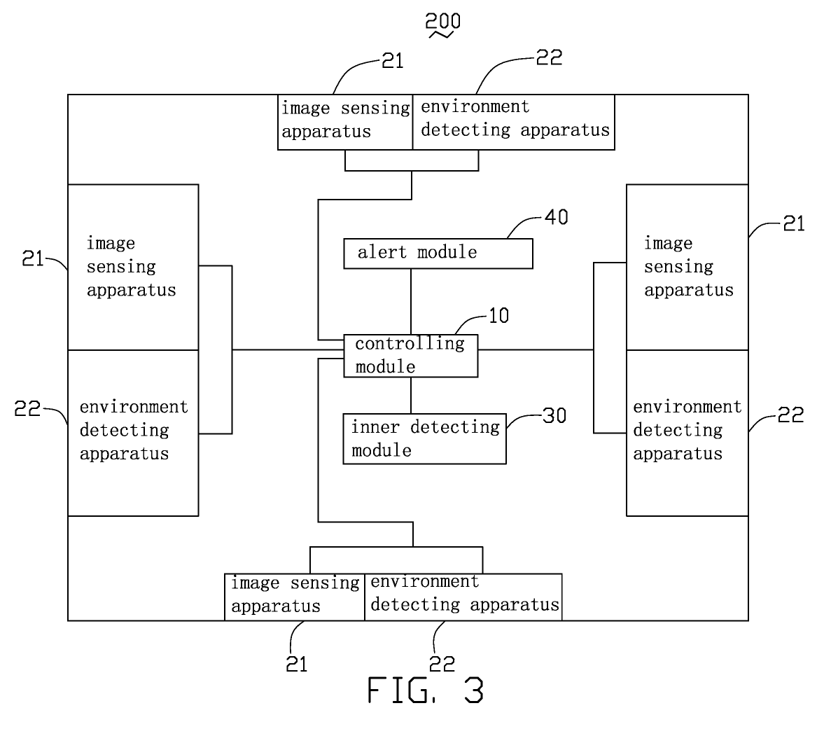

Each outboard detecting module 20 includes a plurality of image sensing apparatuses 21 and a plurality of condition detecting apparatuses 22. Also referring to FIG. 2 and FIG. 3, the plurality of image sensing apparatuses 21 are mounted to receive images from different section/area for example, the front end, the back end and the two sides of an automobile. Each image sensing apparatus 21 includes a lens module 211 and an image sensor 212. The lens module 211 is mounted on an outer surface of the automobile for screening outboard images in a speed faster than 1000 times per second. The image sensor 212 is mounted adjacent to the lens module 211 and electronically connected to the controlling module 10. The image sensor 212 is configured for transforming images screened by the lens module 211 into electronic image signals and transferring the electronic image signals to the controlling module 10 to process.

Similarly to the image sensing apparatuses 21, the plurality of condition detecting apparatuses 22 are also mounted on different section/area of an automobile to detect outboard condition from different directions. Each condition detecting apparatus 22 includes different kinds of detectors (not shown), such as temperature measuring member for measuring outside temperature, distance measuring member for measuring distance with other automobiles, speed measuring member for measuring relative speed to other automobiles, etc. In this way, the condition detecting apparatuses 22 can detect many kinds of data describing outboard condition of an automobile. Each condition detecting apparatus 22 is electronically connected to the controlling module for transforming data to the controlling module 10.

The inner detecting module 30 is installed in an automobile and includes different kinds of detectors for checking different parameters of the automobile, for example, temperature measuring apparatus for measuring temperature in the automobile, distance measuring apparatus for measuring running distance of the automobile, speed measuring apparatus for measuring speed of the automobile, etc. The inner detecting module 30 is electronically connected to the controlling module 10 for transforming data to the controlling module 10.

The alert module 40 includes a displaying apparatus 41 and an alert apparatus 42. The displaying apparatus 41 is a typical visual communication device, such as a display screen. The alert apparatus 42 is a typical acoustical communication device, such as a siren. The displaying apparatus 41 and the alert apparatus 42 are both electronically connected to the controlling module 10, and respectively alert the user via visual mode and acoustical mode according to commands from the controlling module 10.

In use, the recording device 100 is installed in an automobile 200. The driver/passenger of the automobile 200 can set relative parameters of the recording device 100. The recording device 100 can be manually turned on, and can also be set to automatically turn on when the automobile 200 is started.

When the automobile 200 is running, the image sensing apparatus 21 of each outboard detecting module 20 automatically screens outboard images in a speed faster than 1000 times per second. The screened images are transformed into electronic image signals and transferred to the controlling module 10. The image signals are received by the controlling module 10, processed by the processing module 12, and then are transferred to the displaying apparatus 41 to be instantaneously displayed to the driver/passenger.

At the same time, the controlling module 10 can stores the image signals in the storage module 13 in the modes of photos or videos. Furthermore, since the storage space of the storage module 13 is limited, it is not necessary to always store all image signals received by the outboard detecting module 20. The driver/passenger can manually operate the controlling module 10 to selectively store image signals, and the controlling module 10 can automatically store image signals received in special times predetermined by the driver/passenger.

The controlling module 10 also controls the inner detecting module 30 and the condition detecting apparatuses 22 to receive inner and outboard conditions of the automobile. For example, speed of the automobile 200, outside and inner temperature of the automobile 200, distances between the automobile 200 and other automobiles can all be detected by the inner detecting module 30 and the condition detecting apparatuses 22. The measured speed, temperature and distances are transformed into data, and the data is transferred to the controlling module 10. The controlling module 10 then stores the data in the storage module 13 and controls the displaying module 41 to display the data thereon. Additionally, the controlling module 10 can control the alert apparatus 42 for alerting the driver/passenger for errors of the automobile 200.

Understandably, the recording device 100 has both the functions of receiving outboard images instantaneously and storing the received images. In this way, driver/passenger can monitor outboard images via the recording device 100 when driving an automobile.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A recording device installed in an automobile, comprising:
an outboard detecting module including at least one image sensing apparatus configured for transforming images out of the automobile into image signals;
a controlling module electronically connected to the outboard detecting module, and configured for receiving, processing and storing the image signals transferred from the outboard detecting module; and
an alert module electronically connected to the controlling module, and configured for instantaneously displaying the image signals.

2. The recording device as claimed in claim 1, wherein the image sensing apparatus includes a lens module mounted on an outer surface of the automobile, and an image sensor installed in the automobile.

3. The recording device as claimed in claim 1, wherein the outboard detecting module includes a plurality of image sensing apparatuses respectively mounted on different portions of the automobile.

4. The recording device as claimed in claim 1, wherein the outboard detecting module includes at least one condition detecting apparatus configured for detect outboard condition of the automobile.

5. The recording device as claimed in claim 4, wherein the alert module includes a displaying apparatus configured for displaying the image signals.

6. The recording device as claimed in claim 4, wherein the alert module includes an alert apparatus configured for alerting driver/passengers of the automobile.

7. The recording device as claimed in claim 4, further comprising an inner detecting module electronically connected to the controlling module and configured for receiving related data of the automobile condition and transferring the data to the controlling module.

8. The recording device as claimed in claim 7, wherein the controlling module checks errors of the automobile according to the data transferred from the condition detecting apparatus and the inner detecting module, and controls the alert apparatus to alert according to the checking result.

9. The recording device as claimed in claim 7, wherein the controlling module includes a storage module configured for storing the data transferred from the condition detecting apparatus and the inner detecting module.

10. The recording device as claimed in claim 9, wherein the controlling module selectively stores image signals in the storage module.
